(19) United States
(12) Patent Application Publication
(10) Pub. No.: US 2010/0245594 A1
(43) Pub. Date: Sep. 30, 2010

(54) CAMERA CALIBRATION TOOL

(76) Inventors: C. DAVID TOBIE, Mount Vernon, ME (US); Shawn Clark, Hamilton, NJ (US); Joe Reed, Carversville, PA (US)

Correspondence Address: WALL & TONG , LLP, 25 James Way, Eatontown, NJ, 07724, US

(21) Appl. No.: 12/577,462

(22) Filed: Oct. 12, 2009

Related U.S. Application Data
(60) Provisional application No. 61/163,328, filed on Mar. 25, 2009.

(51) Int. Cl. H04N 17/00

(52) U.S. Cl. 348/188; 348/E17.002

(57) ABSTRACT

In one embodiment, the present invention is a camera calibration tool. One embodiment of a three-dimensional test target for calibrating an image capturing device includes a first planar face exhibiting a first color, a second planar face exhibiting a two-toned pattern of a second color and a third color, and a third planar face exhibiting the two-toned pattern of the second color and the third color, wherein the first planar face, the second planar face, and the third planar face meet at a first right-angle convex vertex.

### CROSS REFERENCE TO RELATED APPLICATIONS

This application claimed the benefit of U.S. Provisional Patent Application Ser. No. 61/163,328, filed Mar. 25, 2009, which is herein incorporated by reference in its entirety.

### FIELD OF THE INVENTION

The present invention generally relates to the field of photography, and more specifically relates to the calibration of image capturing devices.

### BACKGROUND OF THE DISCLOSURE

Unlike the human eye, a camera does not automatically see whites as white. To a camera, white looks different indoors, outdoors, at sunset, and at high noon. A camera's automatic settings do not fully correct for this effect. The color of a photographed object is biased according to the spectrum of the available light, and hence may exhibit a blue tint in daylight or an orange tint in incandescent lighting.

### SUMMARY OF THE INVENTION

In one embodiment, the present invention is a camera calibration tool. One embodiment of a three-dimensional test target for calibrating an image capturing device includes a first planar face exhibiting a first color, a second planar face exhibiting a two-toned pattern of a second color and a third color, and a third planar face exhibiting the two-toned pattern of the second color and the third color, wherein the first planar face, the second planar face, and the third planar face meet at a first right-angle convex vertex.

### BRIEF DESCRIPTION OF THE DRAWINGS

The teachings of the present invention can be readily understood by considering the following detailed description in conjunction with the accompanying drawings, in which:

FIG. 1 is an auxiliary view illustrating one embodiment of a test target, according to the present invention; and

FIG. 2 illustrates a net of the cube-shaped body illustrated in FIG. 1, according to one embodiment of the present invention.

### DETAILED DESCRIPTION

In one embodiment, the present invention is a three-dimensional test target comprising at least three planar faces that meet at a right-angle convex vertex. In one particular embodiment, the planar faces are part of a cube-shaped body having a total of six planar faces. The individual planar faces are colored and configured to allow a photographer to control color by balancing light. The test target captures color temperature and light source data for accurate RAW adjustments and more dependable color. The test target surpasses conventional white balance and gray card solutions and can be hung in any environment or mounted to a tripod.

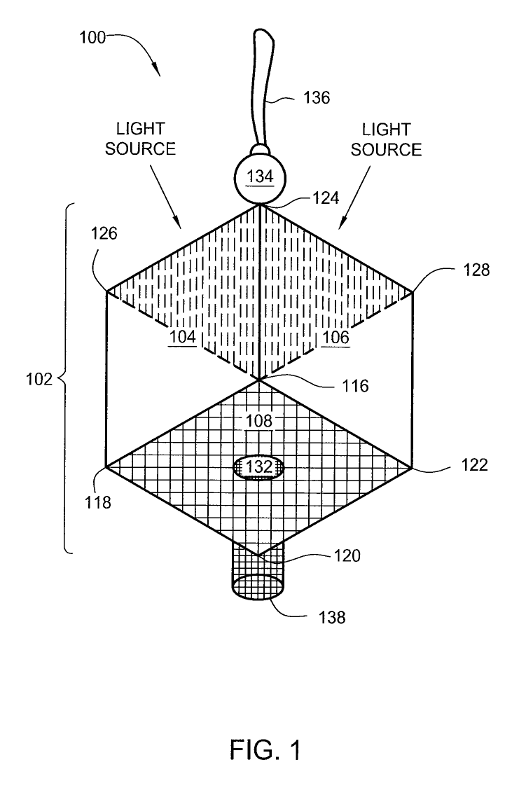

FIG. 1 is an auxiliary view illustrating one embodiment of a test target 100, according to the present invention. As discussed above, the test target 100 may be used by a photographer to aid in calibrating an image capturing device (e.g., a camera) by balancing light.

The test target 100 comprises a three-dimensional body 102 having at least three planar faces: a first face 104, a second face 106, and a third face 108. These three faces 104, 106, and 108 are substantially square and flat and meet at a first right-angle convex vertex 116. Thus, the body 102 resembles one half of a cube. In one embodiment, the body 102 is actually formed as a cube, where the remaining three faces of the cube are not visible in FIG. 1. However, the geometry and configuration of the portions of the body 102 that are not in view in FIG. 1 (e.g., the “back” of the body 102) are secondary to the geometry and configuration of the three faces 104, 106, and 108. In other embodiments, the portions of the body 102 that are not in view in FIG. 1 may simply be flat, or hollow, or may take any other configuration.

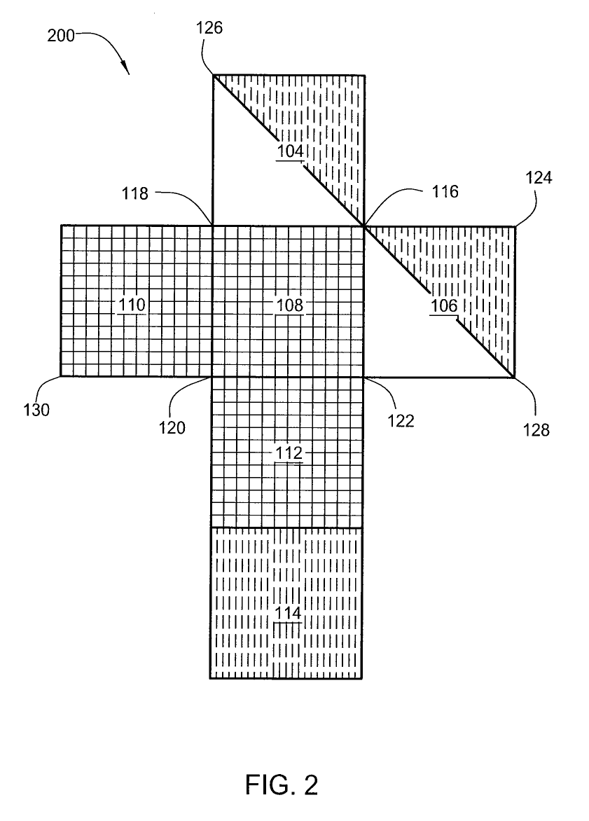

In the embodiment where the body 102 is cube-shaped, the body 102 has six planar faces and eight right-angle convex vertices. Each of the vertices comprises a single point or corner at which three of the six faces meet. Due to the geometry of the body 102, only three of the six faces and seven of the eight vertices are in view in FIG. 1. Thus, to aid in explanation, all faces and vertices of a cube-shaped embodiment of the body 102 are illustrated in FIG. 2. In one embodiment, the body 102 is formed of plastic.

FIG. 2 illustrates a net 200 of the body 102 illustrated in FIG. 1, according to one embodiment of the present invention. Specifically, the net 200 represents a cube-shaped embodiment of the body 102. When folded along the edges, the net 200 forms the cube-shaped body 102. As discussed above, a cube-shaped embodiment of the body 102 has six planar faces: the first face 104, the second face 106, the third face 108, a fourth face 110, a fifth face 112, and a sixth face 114. As also discussed above, the body 102 has eight right-angle convex vertices: the first vertex 116, a second vertex 118, a third vertex 120, a fourth vertex 122, a fifth vertex 124, a sixth vertex 126, a seventh vertex 128, and an eighth vertex 130.

In one embodiment, each of the six faces 104-114 exhibits one of three color options: all a first color, all a second color, or two-toned (e.g., half the first color and half a third color). In one embodiment, a face that is two-toned is split on a diagonal (e.g., such that the face is the first color above the diagonal and the third color below the diagonal). In one embodiment, the first color is gray, the second color is black, and the third color is white. In the embodiment illustrated in FIG. 1 and FIG. 2, the first face 104 and second face 106 are each two-toned; the third face 108, fourth face 110, and fifth face 112 are all the second color; and the sixth face 114 is all the first color. In other embodiments, however, the fourth face 110, fifth face 112, and sixth face 114 may be any color. In addition, a black trap 132 for shadow detail control is formed approximately in the center of the third face 108. The black trap comprises an aperture formed in the third face 108 that opens into interior volume of the body 102 of the test target 100.

As illustrated, the first face 104, second face 106, and third face 108 meet at the fourth vertex 116. Thus, the geometry of the body 102 is such that the faces that are two-toned (i.e., the first face 104 and the second face 106) are adjacent to each other, to the same all second color face (i.e., the third face 108), and to the all first color face (i.e., the sixth face 114). Moreover, the three all second color faces (i.e., the third face 108, fourth face 110, and fifth face 112) are adjacent to each other and meet at a common vertex (i.e., the third vertex 120). In addition the all first color face (i.e., the sixth face 114) is directly opposite the all second color face that is adjacent to both two-toned faces (i.e., the third face 108).

Referring back to FIG. 1, in one embodiment the test target 100 further includes a specular highlight ball 134 coupled to the fifth vertex 104, where the first face 104, second face 106, and sixth face 114 meet. In one embodiment, the specular highlight ball 134 is formed from reflective chrome or includes chrome plating. A hanger 136 is threaded through the specular highlight ball 134. In one embodiment, the hanger 136 is formed from a strong, flexible, wear- and abrasion-resistant material, such as a lanyard or cord. In one embodiment, the hanger 136 includes one or more crimp beads or knots used to secure the specular highlight ball 134 in place. The use of crimp beads may decrease the cost of manufacture relative to the knots.

Also in one embodiment, the test target 100 further comprises a tripod mount 138 coupled to the third vertex 120, where the three all second color faces (i.e., the third face 108, fourth face 110, and fifth face 112) meet. In one embodiment, the tripod mount comprises a threaded rod or protrusion amenable to easy attachment to conventional tripods.

Thus, when the test target 100 is hung (e.g., via the hanger 136) or mounted (e.g., via the tripod mount 138) from one vertex so that an image capturing device views the body 102 along a body diagonal as illustrated in FIG. 1, three faces of the body 102 are exposed to view: the first face 104 at the upper left (divided into first and third colored halves along the face diagonal), the second face 106 at the upper right (divided into first and third colored halves along the face diagonal), and the third face 108 at the bottom (second color, with the black trap 132).

As discussed above, in one embodiment, the two-toned faces (i.e., the first face 104 and the second face 106) are gray and white. This embodiment allows the brightest semi-matte white to always be represented when balancing light from two opposing light sources (e.g., a right hand light source and a left hand light source). For example, if an all gray face were presented to a first light source, while an all white face were presented to an opposing second light source, the brightest semi-matte white would be revealed in an image only if the second light source is dominant with respect to the first light source. This is because one is able to view the effects of the light on only one gray surface. However, by presenting faces that include both gray and white coloring to both light sources, the brightest semi-matte white can be represented with greater certainty.

The substantially identical two-tone patterns on the first face 104 and the second face 106 ensure that, for two different light directions, one can view the effects of the light on two gray surfaces instead of on just one gray surface. In this way, the effects of lighting can be separated from the effects of reflectance of a photographed object. From the photographer's point of view, the white and some gray (e.g., approximately eighteen percent) can be seen simultaneously on either side of the body 102, in whichever configuration the dominant light takes. Thus, in some embodiments, calibration of the image capturing device using the test target 100 requires the photographer to take only a single picture.

Each component of the test target is configured and positioned to facilitate the capture of accurate color. For example, consider a scenario in which the test target 100 is positioned such that the first face 104 is pointed obliquely upward and to the left with respect to an image capturing device, the second face 106 is pointed obliquely upward and to the right, and the third face 108 is pointed obliquely downward. The specular highlight ball 134 is used measure specular highlights by capturing substantially all major frontal light sources. When half of the two-toned faces (i.e., the first face 104 and the second face 106) are white, they are positioned to face primary and secondary light sources and are used to define matte white in relation to highlight. When the other halves of the two-toned faces (i.e., the first face 104 and the second face 106) are spectrally neutral gray, they are positioned to face the primary and secondary light sources and are used to measure color temperature and midtone response. When the third face 108 is black, it is positioned downward for minimal illumination and is used to define shadows in relation to the black trap 132. Finally, the black trap 132 is positioned for minimal light penetration and is used to define absolute black.

The test target 100 therefore allows a photographer to control color by balancing light. The test target 100 captures color temperature and light source data for accurate RAW adjustments and more dependable color. The test target 100 surpasses conventional white balance and gray card solutions and can be hung in any environment or mounted to a tripod.

One of the numerous advantages of the test target 100 is its ability to facilitate the capture of accurate color without a substantial amount of trial and error manipulation. When hung from its hanger 136, the body 102 affords the camera a view of three of its faces (i.e., the first face 104, the second face 106, and the third face 108), along one of its body diagonals. Moreover, the reflectance spectra on all the faces of the body 102 are flat (i.e., spectrally neutral), so the test target 100 responds predictably to substantially all lighting conditions. In one embodiment, the test target 100 provides reference values to check and adjust RAW control settings. In one embodiment, the test target 100 is sized to be portable (e.g., pocket-sized).

In one embodiment, the two-toned faces (i.e., the first face 104 and the second face 106) are extended to multi-colored faces (i.e., colors other than white and gray). In such cases, the third face 108 may still be black. If the body 102 is cube-shaped, the remaining three faces may be any color. Embodiments of the invention comprise faces that include, but are not limited to, neutral colors (i.e., colors that appear to be “without” color, such as beige, ivory, taupe, black, gray, or white). For example, a series of non-neutral colors would be particularly useful for calibration if the reflectance spectra of the non-neutral colors are identical except for a scale factor. Such a scale (corresponding approximately to a value scale in Munsell color space) will provide a set of colors that have the same chromaticity (that sameness being independent of the illuminant spectrum). Deviations from equal chromaticity in the series will then be attributable to the image capturing device (not to the scene) and will be correctable in a digital copy of the image. This is an extension of the same useful property of the neutral scale.

In one embodiment, where the body 102 is cube-shaped, the test target 100 is assembled from two primary injection molded plastic halves. In one embodiment, the plastic has a finish that is the “next-to-finest” matte, which is easy to clean and diffuses local lighting without revealing texture to the image capturing device. In one particular embodiment, the plastic is a semi-matte, custom pigment-impregnated polycarbonate/acrylonitrile butadiene styrene hybrid alloys. Each of the halves forms a “tulip-like” structure, where the first tulip-like structure includes the three all second color faces (i.e., the third face 108, the fourth face 110, and the fifth face 112) and the second tulip-like structure includes the remaining three faces (i.e., the first face 104, and second face 106, and the sixth face 114). In one embodiment of use, the first tulip-like structure forms the bottom of the cube-shaped body 102, while the second tulip-like structure forms the top of the cube-shaped body 102.

In one embodiment, the initial assembly of each two-toned face (i.e., the first face 104 and the second face 106) casts the two colors of the face in the same mold. In one embodiment, the two halves are welded together via an industry-standard ultrasonic-welding process that improves the structural robustness of the body 102.

In one embodiment, the backs of the all second color faces (i.e., the third face 108, the fourth face 110, and the fifth face 112) comprise exposed (e.g., uncoated) black plastic, while an opaque black coating is applied to the backs of the remaining faces (La, the first face 104, and second face 106, and the sixth face 114).

As discussed above, photographing a neutral gray reference for each lighting situation enables one to compensate for bias and to achieve a proper white balance for all photos taken under the lighting situation. In addition, if the neutral gray reference has whites and blacks, it allows the photographer to preserve the visual content of RAW images (i.e., unprocessed, high-bit-content digital files) with fewer bits by clipping unnecessary gray levels below the black and above the white, saving bits. This clipping is performed by a digital application called an “eyedropper,” which, for example, is pointed at a black area, and clipping of all levels is then directed below that black area.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A three-dimensional test target for calibrating an image capturing device, comprising:
a first planar face exhibiting a first color;
a second planar face exhibiting a two-toned pattern of a second color and a third color; and
a third planar face exhibiting the two-toned pattern of the second color and the third color,
wherein the first planar face, the second planar face, and the third planar face meet at a first right-angle convex vertex.

2. The three-dimensional test target of claim 1, wherein the first color is black, the second color is white, and the third color is gray.

3. The three-dimensional test target of claim 1, wherein the two-toned pattern is split on a diagonal such that the second color is below the diagonal and the third color is above the diagonal.

4. The three-dimensional test target of claim 1, wherein the first planar face, the second planar face, and the third planar face together form half of a cube.

5. The three-dimensional test target of claim 4, wherein second planar face and the third planar face meet a fourth planar face at a second right-angle convex vertex.

6. The three-dimensional test target of claim 1, further comprising:
a black trap formed approximately in a center of the first planar face.

7. The three-dimensional test target of claim 1, further comprising:
a tripod mount coupled to the first right-angle convex vertex.

8. The three-dimensional test target of claim 1, further comprising:
a specular highlight ball coupled to a second right-angle convex vertex at which the second planar face and the third planar face meet.

9. The three-dimensional test target of claim 8, further comprising:
a hanger threaded through the specular highlight ball.

10. The three-dimensional test target of claim 1, wherein the three-dimensional test target is formed of plastic.

11. The three-dimensional test target of claim 10, wherein the plastic is a polycarbonate/acrylonitrile butadiene styrene hybrid alloy.

12. The three-dimensional test target of claim 1, wherein the first color, the second color, and the third color are neutral colors.

13. The three-dimensional test target of claim 1, wherein the first color, the second color, and the third color are non-neutral colors.

14. An apparatus for calibrating an image capturing device, comprising:
a cube-shaped body, the cube shaped body comprising:
six faces; and
eight vertices, such that three of the six faces meet at each of the eight vertices,
wherein three of the six faces are colored black, one of the six faces is colored gray, and two of the six faces are colored half white and half gray.

15. The apparatus of claim 14, wherein the two of the six faces that are colored half white and half gray are positioned adjacent to each.

16. The apparatus of claim 15, wherein the two of the six faces that are colored half white and half gray meet one of the three of the six faces that are colored black at a common one of the eight vertices.

17. The apparatus of claim 14, wherein the three of the six faces that are colored black meet at a common one of the eight vertices.

18. The apparatus of claim 14, further comprising:
a black trap formed approximately in a center of one of the three of the six faces that are colored black.

19. The apparatus of claim 14, wherein the two of the six faces that are colored half white and half gray meet one of the one of the six faces that is colored gray at a common one of the eight vertices.

20. The apparatus of claim 19, further comprising:
a specular highlight ball coupled to the common one of the eight vertices.
